(19) United States
(12) Patent Application Publication
(10) Pub. No.: US 2013/0342067 A1
(43) Pub. Date: Dec. 26, 2013

(54) ROTOR OF MOTOR

(71) Applicants: Jeong Cheol Jang, Gwangju (KR); Ji Min Lee, Gwangju (KR)

(72) Inventors: Jeong Cheol Jang, Gwangju (KR); Ji Min Lee, Gwangju (KR)

(73) Assignee: NEW MOTECH CO., LTD., Gwangju (KR)

(21) Appl. No.: 14/001,495

(22) PCT Filed: Jan. 31, 2012
(86) PCT No.: PCT/KR2012/000706

§ 371 Date: Aug. 23, 2013

(30) Foreign Application Priority Data
Apr. 13, 2011 (KR) 10-2011-0034143

(51) Int. Cl. H02K 1/27

(52) U.S. Cl. CPC H02K 1/2786
USPC 310/156.38

(57) ABSTRACT

Disclosed is a rotor of a motor including: a cup-shaped rotor housing having a side wall portion formed along the outer peripheral surface thereof; a rotor core disposed inside the side wall portion of the rotor housing and having a plurality of U-shaped insertion grooves formed therealong; and a plurality of U-shaped magnets adapted to be inserted correspondingly into the plurality of U-shaped insertion grooves of the rotor core.

### TECHNICAL FIELD

The present invention relates to a rotor used in motors, and more particularly, to a rotor of a motor that is capable of reducing cogging torque and noise generated while the motor is being rotated.

### BACKGROUND ART

In general, a motor consists of a stator and a rotor rotatably disposed on the outer or inner periphery of the stator. Accordingly, many studies have been made to reduce the noise or cogging torque occurring during the high speed rotation of the rotor and thus to improve the stability and durability while the motor is being operated.

As one of the conventional practices, therefore, there is disclosed U.S. Pat. No. 5,907,206 wherein a motor is configured to have a rotor core made of a magnetic material and disposed inside a rotor housing and a plurality of rotor magnets disposed inside the rotor core, thereby molding all of the rotor core, the rotor housing and the rotor magnets together by means of a resin. According to the conventional practice, the process for coupling the rotor magnets to the rotor core and the process for performing the resin molding are needed, thereby undesirably making the manufacturing procedure complicated and increasing the manufacturing cost thereof. In addition, since a position sensor is located between the stator and the rotor core, it can be under the influence of the magnetic flux of the stator, thereby making the trouble in the sensing operation thereof. Furthermore, a height of the rotor core in an axial direction is equal to that of the stator core, such that the magnetic flux applied from the rotor acting on the position sensor is weak to cause the position detection of the position sensor to be not performed well.

So as to solve the above-mentioned problems, thus, there is disclosed U.S. Pat. No. 7,317,272 wherein a rotor core has a protrusion formed thereon so as to have a height higher than the height of a stator core and a position sensor is disposed radially or axially opposite to the protrusion of the rotor core.

According to the prior art U.S. Pat. No. 7,317,272, however, the formation of the protrusion on the rotor core causes the steel plate used for making the rotor core to be increased in amount and also causes the magnets inserted into the rotor to be increased in number. Further, if general ferrite magnetic magnets are adopted, a desired magnetic flux is not detected, and so as to obtain good performance, accordingly, neodymium (Nd) magnets should be adopted. As a result, the production cost should be increased. Particularly, the resin molding should be performed to fix the magnets, which raises the production cost and requires additional processes.

So as to solve the above-mentioned conventional problems, thus, this inventors propose to a rotor of a motor wherein a rotor core and magnets are made to have a new structure, without any separate protrusion on the rotor core and any change in the position of a position sensor, thereby obtaining good magnetic flux, and especially, resin molding is not introduced, thereby achieving the reduction of the manufacturing cost and the simplification of the manufacturing process.

### DISCLOSURE OF INVENTION

### Technical Problem

Accordingly, the present invention has been made in view of the above-mentioned problems occurring in the prior art, and it is an object of the present invention to provide a rotor of a motor that is capable of obtaining good magnetic flux during the rotation of the motor, thereby reducing the cogging torque and noise thereof.

It is another object of the present invention to provide a rotor of a motor that is capable of decreasing the production cost thereof.

It is still another object of the present invention to provide a rotor of a motor that is capable of simplifying the manufacturing process thereof.

### Solution to Problem

To accomplish the above objects, according to the present invention, there is provided a rotor of a motor including: a cup-shaped rotor housing having a side wall portion formed along the outer peripheral surface thereof; a rotor core disposed inside the side wall portion of the rotor housing and having a plurality of U-shaped insertion grooves formed therealong; and a plurality of U-shaped magnets adapted to be inserted correspondingly into the plurality of U-shaped insertion grooves.

According to the present invention, desirably, each U-shaped insertion groove has an arc-shaped inner peripheral portion, an outer peripheral portion having an arc length longer than the inner peripheral portion and formed in an outside direction thereof, and side portions connecting both end portions of the inner peripheral portion and the outer peripheral portion with each other, and each U-shaped magnet has an inner peripheral surface adapted to be contacted partially or entirely with the inner peripheral portion of each U-shaped insertion groove, an outer peripheral surface adapted to be contacted partially or entirely with the outer peripheral portion of each U-shaped insertion groove, and side surfaces adapted to be contacted partially or entirely with the side portions of each U-shaped insertion groove.

According to the present invention, desirably, the side portions of each U-shaped insertion groove and the side surfaces of each U-shaped magnet are formed inwardly.

According to the present invention, desirably, the rotor core, the plurality of U-shaped magnets, and a stator core have the same axial length as each other.

According to the present invention, desirably, each U-shaped magnet is coupled by means of a curing adhesive.

According to the present invention, desirably, each U-shaped magnet is a ferrite magnet.

### Advantageous Effects of Invention

According to the present invention, there is provided the rotor of a motor that is capable of obtaining good magnetic flux during the rotation of the motor, thereby reducing the cogging torque and noise thereof, decreasing the production cost thereof, and simplifying the manufacturing process thereof.

### BRIEF DESCRIPTION OF DRAWINGS

FIG. 1 is a plane view showing a rotor of a motor according to the present invention.

FIG. 2 is a plane view showing a rotor core adopted for the rotor of a motor according to the present invention.

FIG. 3 is a perspective view showing one of a plurality of U-shaped magnets in the rotor of a motor according to the present invention.

FIG. 4 is a plane view showing the coupled state wherein the rotor of a motor according to the present invention is coupled to a stator.

### BEST MODE FOR CARRYING OUT THE INVENTION

Hereinafter, an explanation on a rotor of a motor according to the present invention will be in detail given with reference to the attached drawings.

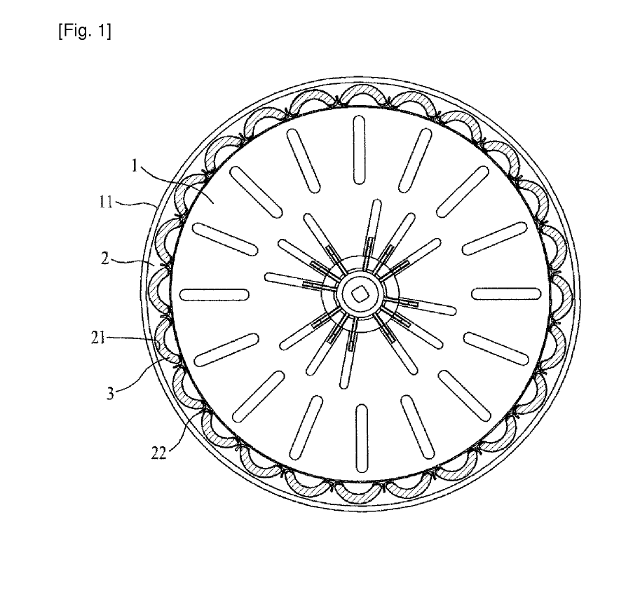

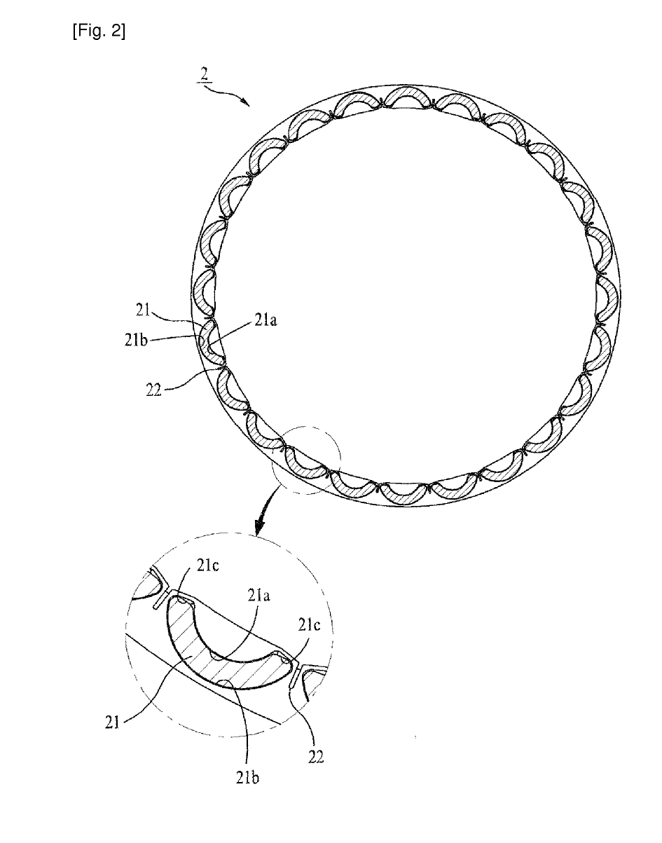

FIG. 1 is a plane view showing a rotor of a motor according to the present invention, and FIG. 2 is a plane view showing a rotor core 2 adopted for the rotor of a motor according to the present invention.

As shown in FIG. 1, the rotor of a motor according to the present invention largely includes a rotor housing 1, a rotor core 2, and a plurality of U-shaped magnets 3. The rotor housing 1 has a side wall portion 11 formed along the outer peripheral surface thereof, thereby taking a generally cup-like shape. The rotor core 2 is made of a magnetic material and desirably, it is made by blanking thin steel plates and stacking the blanked steel plates on top of each other. The rotor core 2 has a plurality of U-shaped insertion grooves 21 into which the plurality of U-shaped magnets 3 are inserted. Accordingly, the rotor core 2 has such a shape as shown in FIG. 2.

Desirably, the rotor core 2 as shown in FIG. 2 is forcedly pressed and fitted inside the side wall portion of the rotor housing 1, thereby being coupled to the rotor housing 1. Accordingly, the rotor housing 1 and the rotor core 2 can be coupled to each other, without any need of insert injection molding or separate resin molding materials.

As shown in FIG. 2, the plurality of U-shaped insertion grooves 21 are formed along the periphery of the rotor core 2. Each U-shaped insertion groove 21 has an arc-shaped inner peripheral portion 21a, an outer peripheral portion 21b having an arc length longer than the inner peripheral portion 21a and formed in an outside direction thereof, and side portions 21c connecting both end portions of the inner peripheral portion 21a and the outer peripheral portion 21b with each other. The term, ‘outside direction’ used in the present invention is headed outwardly from the center (the axial portion) of the rotor. Further, the term, ‘axial direction’ used in the present invention means the direction toward which the rotary axis is headed, that is, the direction toward the surface of the sheet of paper in FIG. 1 or FIG. 2. If it is assumed that the plane on the drawing is xy, the axial direction becomes z axial direction and the outside direction becomes the direction toward which the absolute value of x axis or y axis is increased. The inside direction means the opposite direction to the outside direction.

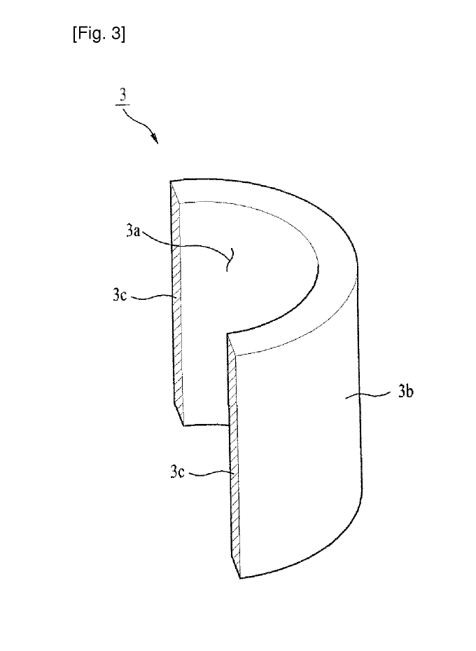

Like this, when viewed in the axial direction, each U-shaped insertion groove 21 is U-shaped. Desirably, the side portions 21c formed on the both ends of each U-shaped insertion groove 21 are located toward the inside direction, thereby improving the magnetic flux performance together with the U-shaped magnets 3. Each U-shaped magnet 3 has such a shape as shown in FIG. 3.

FIG. 3 is a perspective view showing one of the plurality of U-shaped magnets 3 in the rotor of a motor according to the present invention.

As shown in FIG. 3, each U-shaped magnets 3 has an inner peripheral surface 3a, an outer peripheral surface 3b, and side surfaces 3c.

When viewed in the axial direction, each U-shaped magnet 3 is U-shaped, such that the length of the arc of the inner peripheral surface 3a is shorter than that of the outer peripheral surface 3b. Further, the side surfaces 3c, which connect the inner peripheral surface 3a and the outer peripheral surface 3b and are formed in the axial direction, are headed toward the inside direction. The inner peripheral surface 3a is disposed contacted partially or entirely with the inner peripheral portion 21a of each U-shaped insertion groove 21 of the rotor core 2, the outer peripheral surface 3b with the outer peripheral portion 21b thereof, and the side surfaces 3c with the side portions 21c. So as to improve the coupling state of the U-shaped magnets 3, an adhesive may be applied partially or entirely to the inner peripheral surface 3a, the outer peripheral surface 3b and the side surfaces 3c. Desirably, the adhesive becomes a curing adhesive that is curable at a room temperature, and if necessary, the adhesive becomes a thermosetting adhesive.

The axial length of each U-shaped magnet 3, that is, the length h in FIG. 3 is the same as those of the rotor core 2 and a stator core 4. Under the structure of the present invention, accordingly, since the magnetic flux is not decreased, there is no need to make the length h larger than the axial length of the stator core 4 so as to prevent the magnetic flux from being decreased. Additionally, there is no need to move the position of a hall sensor to the outside of the rotor or to the upper side in the axial direction so as to detect the magnetic flux.

On the other hand, as shown in FIGS. 1 and 2, a gap 22 is formed opened inwardly between the adjacent U-shaped insertion grooves 21. The formation of the gap 22 ensures the magnetic flux to be stably provided, thereby reducing the cogging torque and noise occurring during high speed rotation.

Like this, since good magnetic properties are ensured through the structure in which the U-shaped magnets 3 are inserted into the U-shaped insertion grooves 21 of the rotor core 2 and through the gap 22 formed between the adjacent U-shaped insertion grooves 21, ferrite magnets, not neodymium magnets, can be used as the U-shaped magnets 3. At this time, the rotor according to the present invention has the magnetic flux larger than the rotor in the conventional practice wherein the neodymium magnets are adopted. Accordingly, the manufacturing cost and process can be simplified, and besides, the cogging torque and noise occurring during the high speed rotation of the motor can be reduced.

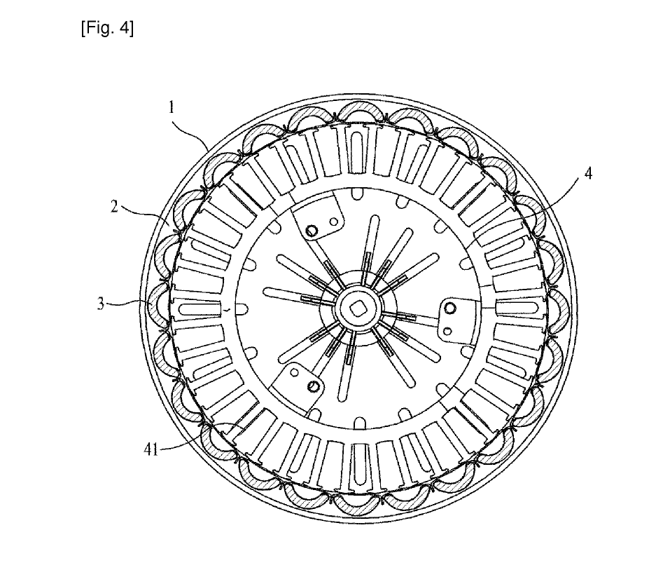

FIG. 4 is a plane view showing the coupled state wherein the rotor of a motor according to the present invention is coupled to a stator.

As shown in FIG. 4, the stator core 4 is disposed inside the rotor core 2, and a plurality of teeth 41 is formed along the outer periphery of the stator core 4. A coil (not shown) is wound around each of the teeth 41. The ends of the teeth 41 face the inner periphery of the rotor core 2. As described above, the axial length of the stator core 4 is the same as those of the rotor core 2 and the U-shaped magnets 3. Accordingly, the material costs required for the magnets 3 and the rotor core 2 can be reduced.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A rotor of a motor comprising:
a cup-shaped rotor housing 1 having a side wall portion 11 formed along the outer peripheral surface thereof;
a rotor core 2 disposed inside the side wall portion 11 of the rotor housing 1 and having a plurality of U-shaped insertion grooves 21 formed therealong; and
a plurality of U-shaped magnets 3 adapted to be inserted correspondingly into the plurality of U-shaped insertion grooves 21 of the rotor core 2.

2. The rotor of a motor according to claim 1, wherein each U-shaped insertion groove 21 of the rotor core 2 has an arc-shaped inner peripheral portion 21 a, an outer peripheral portion 21b having an arc length longer than the inner peripheral portion 21a and formed in the outside direction thereof, and side portions 21c connecting both end portions of the inner peripheral portion 21a and the outer peripheral portion 21b with each other, and each U-shaped magnet 3 has an inner peripheral surface 3a adapted to be contacted partially or entirely with the inner peripheral portion 21a of each U-shaped insertion groove 21, an outer peripheral surface 3b adapted to be contacted partially or entirely with the outer peripheral portion 21b of each U-shaped insertion groove 21, and side surfaces 3c adapted to be contacted partially or entirely with the side portions 21c of each U-shaped insertion groove 21.

3. The rotor of a motor according to claim 2, wherein the side portions 21c of each U-shaped insertion groove 21 and the side surfaces 3c of each U-shaped magnet 3 are formed inwardly.

4. The rotor of a motor according to claim 4, wherein the rotor core 2, the plurality of U-shaped magnets 3, and a stator core 4 have the same axial length as each other.

5. The rotor of a motor according to claim 1, wherein each U-shaped magnet 3 is coupled by means of a curing adhesive.

6. The rotor of a motor according to claim 1, wherein each U-shaped magnet 3 is a ferrite magnet.

7. A rotor core made by stacking a plurality of thin steel plates on top of each other, each thin steel plate having a plurality of U-shaped insertion grooves 21 formed thereon, and each U-shaped insertion groove 21 having an arc-shaped inner peripheral portion 21a, an outer peripheral portion 21b formed in an outside direction with respect to the inner peripheral portion 21a, and side portions 21c connecting both end portions of the inner peripheral portion 21a and the outer peripheral portion 21b with each other.

8. The rotor of a motor according to claim 2, wherein each U-shaped magnet 3 is a ferrite magnet.

9. The rotor of a motor according to claim 3, wherein each U-shaped magnet 3 is a ferrite magnet.

10. The rotor of a motor according to claim 4, wherein each U-shaped magnet 3 is a ferrite magnet.

11. The rotor of a motor according to claim 5, wherein each U-shaped magnet 3 is a ferrite magnet.
